(19) United States
(12) Patent Application Publication
(10) Pub. No.: US 2024/0046607 A1
(43) Pub. Date: Feb. 8, 2024

(54) IMAGE ANALYSIS MACHINE LEARNING SYSTEMS AND METHODS TO IMPROVE DELIVERY ACCURACY

(71) Applicant: Capital One Services, LLC, McLean, VA (US)

(72) Inventors: Leeyat Bracha Tessler, Arlington, VA (US); Tyler Maiman, Melville, NY (US); Phoebe Atkins, Midlothian, VA (US)

(21) Appl. No.: 17/879,719

(22) Filed: Aug. 2, 2022

(51) Int. Cl. G06V 10/75; G06V 10/40; G06V 10/774; G06Q 10/08

(52) U.S. Cl. CPC G06V 10/751; G06V 10/40; G06V 10/774; G06Q 10/083

(57) ABSTRACT

The disclosed technology relates to assessing and securing credit risk using creditworthiness tokens issued in a blockchain network responsive to particular financial events. An exemplary blockchain node device may store an issuance smart contract associated with an identity and including a first wallet address and allocation parameters. An event query may be sent to an oracle device external to the blockchain network. The event query may include the identity. Event data associated with the identity may then be received from the oracle device in response to the event query. A number of creditworthiness tokens is determined based on an application of the allocation parameters to the event data. The determined number of creditworthiness tokens is then allocated to the identity via the first wallet address. Thereafter, the creditworthiness tokens can be transferred or collateralized, e.g., and can represent creditworthiness for the identity across financial institutions.

### FIELD

The disclosed technology generally relates to improving package delivery accuracy using image analysis and machine learning systems and methods, and more particularly to methods and systems that use a trained machine learning model to automatically determine the likelihood that a package was delivered to an appropriate location based on an analysis of environmental features of a captured image of the delivered package.

### BACKGROUND

With increasing online shopping and grocery deliveries, among others, parcel and other package shipping and delivery volume has consistently trended upward in recent years. The increased delivery volume has led to a corresponding rise in inaccurate deliveries to wrong addresses. Inaccurate deliveries can result in stolen packages, failed or delayed receipt of purchased goods, environmental harm to packages or associated goods, and inefficiencies related to returned packages, among other issues.

### BRIEF SUMMARY

Examples of the present disclosure provide solutions to issues associated with inaccurate package delivery that may result from reliance on GPS coordinate and address correlations, for example. Disclosed embodiments may provide, for example, delivery management systems that train a machine learning model based on sets of images associated with the same location or address. Subsequent to deployment, the delivery management systems may apply the trained machine learning models to images of delivered packages obtained from carrier mobile devices to determine a likelihood that environmental features in the obtained images correspond with intended delivery addresses for the delivered packages. If a likelihood is below a threshold, the delivery management systems can generate and send an alert to the carrier mobile device promptly in order to flag the potential for, and facilitate the immediate addressing of, inaccurate package deliveries. Carrier and recipient feedback is then used to continuously train and improve the machine learning models.

The disclosed technology may include a delivery management system that may include one or more processors and memory in communication with the one or more processors and storing instructions that, when executed by the one or more processors, are configured to cause the delivery management system to perform one or more methods. For example, the delivery management system may receive a delivery address and an image of a delivered package from a carrier device via a first communication network. The image comprises one or more environmental features associated with a physical location at which the delivered package was delivered. A machine learning model is applied to the image to generate a confidence score indicative of whether the environmental features correspond to the delivery address. An alert message is then sent to the carrier device via the first communication network when the confidence score is determined to be below a stored confidence threshold. Carrier feedback data is received from the carrier device in response to the alert message and a determination is made that the carrier feedback data is positive. A delivery confirmation request is then sent to a recipient device, via a second communication network and based on obtained recipient contact data associated with the delivery address. Recipient feedback data is then received in response to the delivery confirmation request. The machine learning model is then updated based on the recipient feedback data.

The disclosed technology may include another delivery management system that may include one or more processors and memory in communication with the one or more processors and storing instructions that, when executed by the one or more processors, are configured to cause the delivery management system to perform one or more methods. For example, the delivery management system may receive a delivery address and a first image of a package from a carrier device. The first image comprises a first set of one or more environmental features. A machine learning model is applied to the first image to generate a confidence score indicative of a likelihood that the first set of environmental features corresponds to the delivery address. An alert is sent to the carrier device when a determination is made that the confidence score is below a confidence threshold value. Carrier feedback data is received from the carrier device in response to the alert. A second image of the package is received from the carrier device when the carrier feedback data is negative. The second image comprises a second set of one or more environmental features. At least the application and the determination are repeated for the second image.

The disclosed technology may include yet another delivery management system that may include one or more processors and memory in communication with the one or more processors and storing instructions that, when executed by the one or more processors, are configured to cause the delivery management system to perform one or more methods. For example, the delivery management system may receive a delivery address and an image of a package from a carrier device via a first network. The image comprises one or more environmental features associated with a location at which the package was delivered. A machine learning model is applied to the image to generate a confidence score indicative of whether the environmental features correspond to the delivery address. The machine learning model is configured to compare the image to a set of one or more images associated with the delivery address. The image is stored in the set of images associated with the delivery address when a determination is made that the confidence score is above a confidence threshold.

Other embodiments, features, and aspects of the disclosed technology are described in detail herein and are considered a part of the claimed disclosed technologies. Other embodiments, features, and aspects can be understood with reference to the following detailed description, accompanying drawings, and claims.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner In the drawings:

FIG. 1 is a block diagram of an example system environment that includes a delivery management device, carrier device, recipient device, and storage servers, in accordance with one or more examples of the disclosed technology;

FIG. 2 is a component diagram of a delivery management system, in accordance with one or more examples of the disclosed technology;

FIG. 3 is a flow diagram of an example method for training and deploying a machine learning model, in accordance with one or more examples of the disclosed technology;

FIG. 4 is a flow diagram of an example method for using a trained machine learning model to automatically determine the likelihood that a package was delivered to an appropriate location, in accordance with one or more examples of the disclosed technology;

FIG. 5 is a timing diagram of an example method for identifying a potentially-inaccurate package delivery and continuously training a machine learning model, in accordance with one or more examples of the disclosed technology.

### DETAILED DESCRIPTION

As package delivery volume has increased, packages are increasingly delivered to the wrong locations and addresses leading to significant inefficiencies in the last-mile shipment industry. Last mile carriers currently use mobile devices for several purposes during package delivery. For example, carriers can use mobile devices to capture images of delivered packages, which can then be reported to or retrieved by intended recipients (e.g., via e-mail and/or web application). However, by the time an intended recipient obtains an image depicting a delivered package at an incorrect location, the carrier may be at another location and incapable of addressing the inaccurate delivery. Additionally, a picture of another's front porch, for example, may not help the intended recipient identify the package location or facilitate its accurate delivery to the intended recipient.

In another example, carrier mobile devices can include a global positioning system (GPS) transceiver that can determine a geolocation, which can be compared with an intended package delivery address. However, GPS coordinates are generally unreliable, particularly in locations of higher density housing. For example, GPS coordinates may not be sufficient to distinguish neighbors that share a contiguous wall or are on a floor above or below one another. Accordingly, there is currently no effective way to identify, or contemporaneously notify last mile carriers of, a potentially-inaccurate package delivery.

As will be described and illustrated in more detail below, examples of the disclosed technology may provide solutions to issues associated with inaccurate package delivery that may result from reliance on GPS coordinate and address correlations, for example. Disclosed embodiments may provide, for example, delivery management systems that train a machine learning model based on sets of images associated with the same location or address. Subsequent to deployment, the delivery management systems may apply the trained machine learning models to images of delivered packages obtained from carrier mobile devices to determine a likelihood that environmental features in the obtained images correspond with intended delivery addresses for the delivered packages. If a likelihood is below a threshold, the delivery management systems can generate and send an alert to the carrier mobile device promptly in order to flag the potential for, and facilitate the immediate addressing of, inaccurate package deliveries. Carrier and recipient feedback is then used to continuously train and improve the machine learning models.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to exemplary embodiments of the disclosed technology, examples of which are illustrated in the accompanying drawings and disclosed herein. Wherever convenient, the same reference numbers will be used throughout the drawings to refer to the same or like parts.

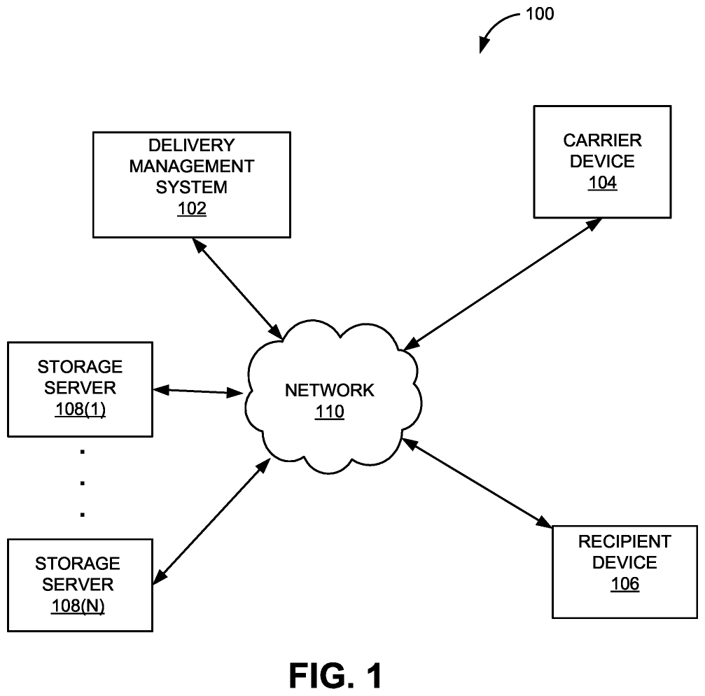

FIG. 1 is a block diagram of an example system environment 100 that includes a delivery management system 102, carrier device 104, recipient device 106, and storage servers 108(1)-108(n), in accordance with one or more examples of the disclosed technology. The delivery management system 102, carrier device 104, recipient device 106, and storage servers 108(1)-108(n) are coupled together via a network 110 (e.g., a communication network, one or more local area networks (LANs), and/or one or more wide area networks (WANs)).

Each of the carrier device 104 and the recipient device 106 can be a mobile computing device (e.g., a smart phone, tablet computer, smart wearable (e.g., a smart watch), portable laptop computer, voice command device, smart glasses, wearable augmented reality device, or other mobile computing device). In other examples, the recipient device can be a stationary device (e.g., desktop computer). The carrier device 104 can host a standalone or web application, for example, that is configured to communicate over the network 110 with the delivery management system 102 to exchange package delivery information, including delivery unique identifiers, address information, delivery package images, notification messages regarding potentially-inaccurate deliveries, and/or carrier feedback messages reflective of delivery accuracy, for example.

Additionally, the recipient device 106 can receive information regarding package deliveries (e.g., box, envelope, or any other type of container for documents or objects), including delivery status and the delivered package images, from the delivery management system 102, as well as exchange recipient feedback messages with the delivery management system 102, among other types of communications across the network 110. The delivery management system 102 can leverage the storage servers 108(1)-108(n) to store the delivered images. In other examples, one or more of the storage servers 108(1)108(n) can be hosted by third parties and can provide images of addresses that can be used during the application of the machine learning models, for example, as described and illustrated in more detail later.

Each of the carrier device 104, the recipient device 106, and the storage servers 108(1)-108(n) can include a processor, memory, and data storage. The processor can include one or more of a microprocessor, microcontroller, digital signal processor, co-processor or the like or combinations thereof capable of executing stored instructions and operating upon stored data.

The memory of the carrier device 104, the recipient device 106, and/or the storage servers 108(1)-108(n) can include, in some implementations, one or more suitable types of memory (e.g., volatile or non-volatile memory, random access memory (RAM), read only memory (ROM), magnetic disks, optical disks, hard disks, flash memory, solid state drives, non-transitory computer-readable medium, and the like), for storing files and/or applications (e.g., a web browser application, a widget or gadget engine, and or other applications, as necessary), executable instructions and data.

The memory of the carrier device 104, the recipient device 106, and/or the storage servers 108(1)-108(n)can contain an operating system (OS) that can run program(s). The program(s) can perform one or more functions of the disclosed examples, such as explained in detail below. The carrier device 104 further includes an imaging device (e.g., a camera) capable of capturing images with the program(s) of the memory of the carrier device 104 configured to transmit the captured images (e.g., to the delivery management system 102), as explained in more detail below.

The carrier device 104, the recipient device 106, and/or the storage servers 108(1)-108(n) can also include a communication interface for communicating with external systems or internal systems. The communication interface can include a transceiver to communicate with compatible devices, for example via short range, long range, or similar technologies that enables the of the carrier device 104, the recipient device 106, and/or the storage servers 108(1)-108(n) to communicate via the network 110 described herein.

The network 110 can include LANs and/or WANs, for example, and can use an Ethernet-based and/or Internet protocol (IP) (e.g., Hypertext Transfer Protocol (HTTP)) to exchange information. The network 110 can, therefore, facilitate transmission of delivered package images from the carrier device 104 to the delivery management system 102 and alert messages from the delivery management system 102 to the carrier device 104, among other types of messages and information.

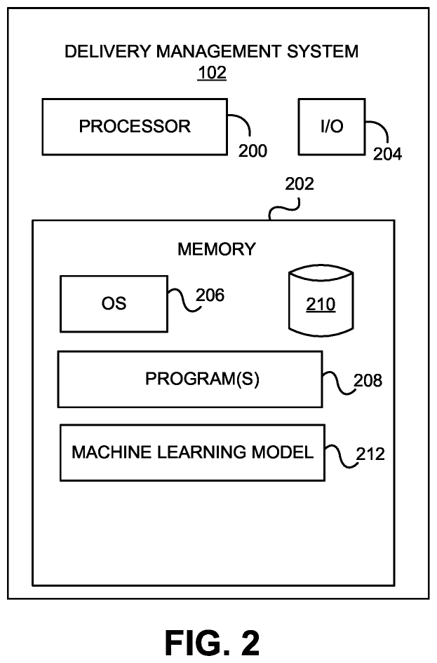

FIG. 2 is a component diagram of the delivery management system 102, in accordance with one or more examples of the disclosed technology. The delivery management system 102 can include a processor 200, memory 202, and an input/output (I/O) interface 204. The processor 200 can include one or more of a microprocessor, microcontroller, digital signal processor, co-processor or the like or combinations thereof capable of executing stored instructions and operating upon stored data.

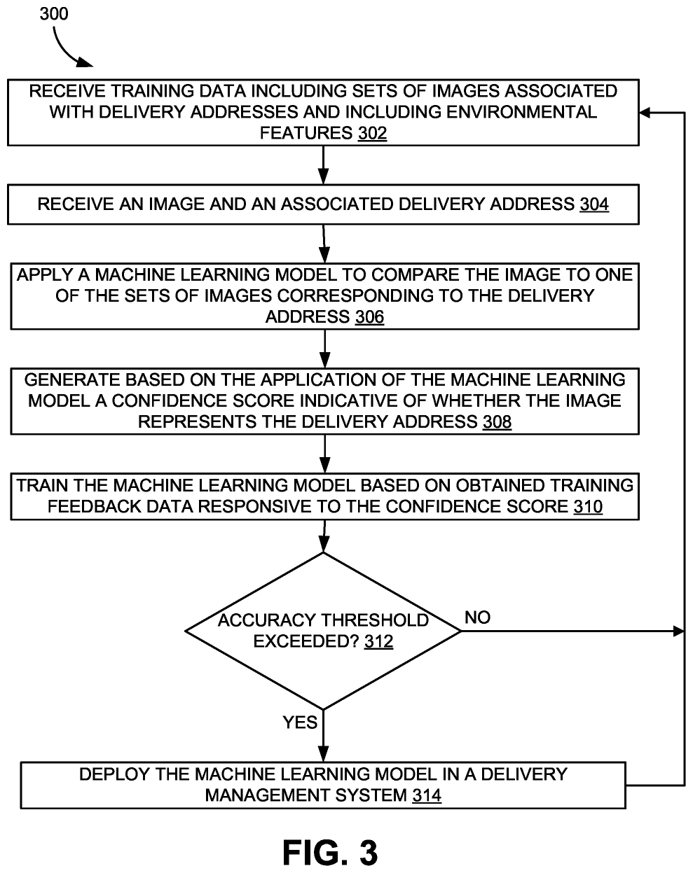

The memory 202 of the delivery management system 102 can include, in some implementations, one or more suitable types of memory (e.g., volatile or non-volatile memory, RAM, ROM, magnetic disks, optical disks, hard disks, removable cartridges, flash memory, solid state drives, non-transitory computer-readable medium, and the like), for storing files and/or application, executable instructions, and data. The memory 202 can contain an Operating System (OS) 206 that can run program(s) 208. The program(s) 208 can perform one or more functions of the disclosed examples, as explained in detail below with reference to FIGS. 3-5, for example.

The memory 202 can also include a delivery database 210 and a machine learning model 212. The delivery database 210 can include any combination of one or more databases controlled by memory controller devices (e.g., server(s), etc.) or software, such as document management systems, Microsoft® SQL databases, SharePoint® databases, Oracle® databases, Sybase® databases, or other relational databases.

The machine learning model 212 can be generated via supervised or unsupervised training (e.g., as explained in more detail below with reference to FIG. 3) and may utilize deep learning models, such as a convolutional neural network (CNN) or long short-term memory (LSTM), for example. In other examples, the machine learning model 212 may be a binary classifier, such as a Support Vector Machine (SVM), Logistic Regression, Random Forest, or XGBoost, for example, although other types of machine learning models can also be used in other examples. The machine learning model 212 is trained to analyze images to generate a score reflective of the likelihood that the images represent a particular address, as explained in more detail below.

The I/O interface 204 can include a serial port, a parallel port, an Ethernet port, a general-purpose input and output (GPIO) port, a game port, a universal serial bus (USB), a micro-USB port, a high definition multimedia (HDMI) port, a video port, an audio port, a Bluetooth™ port, a Near Field Communication (NFC) port, another like communication interface, or any combination thereof. The I/O interface 204 can include a transceiver to communicate with compatible devices, for example via short range, long range, or similar technologies that enables the delivery management system 102 to communicate via the network 110 described herein.

FIG. 3 is a flow diagram of an example method 300 for training and deploying the machine learning model 212, in accordance with one or more examples of the disclosed technology. Method 300 may be performed by the delivery management system 102, which includes the processor 200 and memory 202 in communication with the processor 200 and storing instructions. When executed by the processor 200, the stored instructions cause the delivery management system 102 to perform certain functions, such as one or more steps described and illustrated herein with reference to method 300.

In block 302 in this example, the delivery management system 102 may receive training data including sets of images, each of which is associated with a same delivery address (e.g., a physical street address). Each of the images in a particular set of images includes environmental features associated with a physical location at the delivery address, such as a doormat, a door color, porch pillars, door steps, particular vegetation (e.g., bushes, tress, plants), a house color, sidelight window configuration, entrance walkway, house or apartment number, etc. Optionally, the various images within one or more of the sets of images can reflect the same location associated with the same address but be captured at a different time of day, level of daylight, angle, and/or proximity to the delivery location (e.g., doorstep) at the address, among other variations.

In some examples, one or more of the images in one or more of the sets of images can be obtained from a third party (e.g., via one or more of the storage servers 108(1)-108(n)). For example, the Street View™ web application available from Alphabet Inc. of Mountain View, CA provides an Application Programming Interface (API) to facilitate retrieval of stored static images captured from vehicle road locations. Other sources of the images in the training data can also be used in other examples.

In block 304, the delivery management system 102 may receive an image and an associated delivery address. The image received in some iterations of block 304 can be associated with, and reflect or depict, a delivery address for which a set of images was received in block 302 with the training data. In other iterations of block 304, the received image can be associated with a delivery address for which a set of images was received in block 302 with the training data, but the image does not reflect or depict that delivery address. By providing true and false images within the training data, the delivery management system 102 can generate a more accurate and robust machine learning model 212.

In block 306, the delivery management system 102 may apply the machine learning model 212 to compare the image to one of the sets of images corresponding to the delivery address identified as associated with the received image in block 304. The comparison can be based on particular extracted or classified environmental features, a pixel-by-pixel or sub-image analysis, or any number of other comparison techniques to determine the likelihood that the image received in block 304 belongs in the set of images associated with the same delivery address in the training data, or otherwise corresponds to that delivery address.

In block 308, the delivery management system 102 may generate a confidence score based on the application of the machine learning model 212. The confidence score is indicative of whether the image represents the delivery address to which it is asserted to correspond based on the association received in block 304. The confidence score can be based on any number of factors such as the number and/or type of overlapping or matching extracted environmental features (e.g., a blue front door, white siding, doormat, and bushes on either side of the front door) with one or more images in the set of images of the training data.

In some examples, the confidence score is higher when more environmental features in the received image have a match in a greater number of images in the relevant set of images of the training data. In other examples, particular matching environmental features can be weighted more heavily. For example, colors of doors and siding, vegetation, and other environmental features more likely or amenable to change over time may be weighted less heavily in the generation of the confidence score. Other methods for generating the confidence score using the machine learning model 212 can also be used in other examples.

In block 310, the delivery management system 102 may train the machine learning model based on obtained training feedback data responsive to the confidence score. Accordingly, in the supervised training method 300, the delivery management system 102 may receive training feedback data following output of the confidence score generated in block 308. The training feedback data can include an indication of whether the confidence score was accurate or should have been higher or lower, for example Based on the training feedback data, the machine learning model 212 is trained in some examples to weigh types of environmental features differently than others.

For example, if the training feedback data indicates that the confidence score should have been higher and the received image reflects a matching front door sidelight configuration but a different color front door, the machine learning model 212 may learn over time that the front door sidelight configuration may be weighted more heavily than front door color (e.g., as a result of the color being subject to change via painting). Other methods for training the machine learning model 212, including unsupervised methods, can also be used in other examples.

In block 312, the delivery management system 102 may determine whether the machine learning model 212 has achieved or exceeded an accuracy threshold. In some examples, the delivery management system 102 can automatically analyze the accuracy of the machine learning model 212 based on a ratio of the number of correct confidence scores, or confidence scores accurate within an established error margin, to the total number of input samples, with the ratio or percentage being configurable according to a desired tolerance.

In other examples, logarithmic loss, confusion matrix, F1 score, mean absolute error, and/or mean squared error methods can also be used to evaluate accuracy of the machine learning model 212, and other methods for determining the machine learning model 212 is ready for deployment in a live environment can also be used. If the delivery management system 102 determines in block 312 that the accuracy of the machine learning model 212 does not exceed the accuracy threshold, then the “No” branch is taken back to block 302 and the delivery management system 102 continues training the machine learning model 212. However, if the delivery management system 102 determines in block 312 that the accuracy threshold has been exceeded, then the “Yes” branch is taken to block 314.

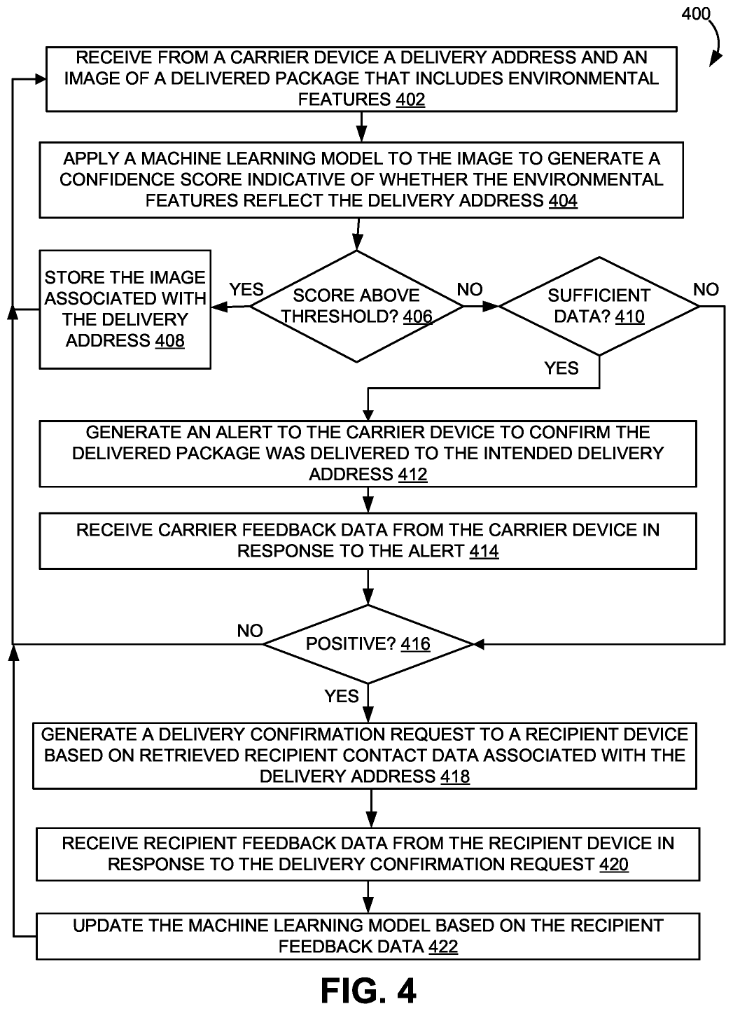

In block 314, the delivery management system 102 may deploy the machine learning model 212 in a live environment. Accordingly, the deployed machine learning model 212 in this example is sufficiently trained to satisfy an accuracy threshold and will yield relatively accurate confidence scores based on an image comparison when a predefined number of stored images for a delivery address are available for comparison with a current image captured by the carrier device 104 for the delivery address. The trained and deployed machine learning model 212 can be used by the delivery management system 102 as described and illustrated below with reference to block 404 of FIG. 4, for example.

Subsequent to deploying the machine learning model 212, the delivery management system 102 can proceed back to block 302 and continue training to improve accuracy. In other examples, the delivery management system 102 can discontinue the training subsequent to deployment. In yet other examples, the accuracy of the machine learning model 212 can be periodically tested using different input data and, if the accuracy falls below the accuracy threshold, the delivery management system 102 can reinitiate the training. One or more of blocks 302-314 can occur in a different order and/or in parallel in other examples, and other methods for training the machine learning model 212 can also be used, including unsupervised training methods.

FIG. 4 is a flow diagram of an example method 400 for using the trained machine learning model 212 to automatically determine the likelihood that a package was delivered to an appropriate location, in accordance with one or more examples of the disclosed technology. Method 400 also may be performed by the delivery management system 102, which includes the processor 200 and memory 202 in communication with the processor 200 and storing instructions. When executed by the processor 200, the stored instructions cause the delivery management system 102 to perform certain functions, such as one or more steps described and illustrated herein with reference to method 400.

In block 402, the delivery management system 102 may receive from the carrier device 104 a delivery address and an image of a delivered package. While the address is sent via the network 110 to the delivery management system 102 in this example, in other examples, the carrier device 104 can transmit a unique identifier associated with the delivered package or any other indicia from which the delivery management system 102 can determine the delivery address (e.g., from a local database or an external source, such as a database hosted by the carrier). The image of the delivered package includes environmental features associated with the location of the delivered package (e.g., physical feature(s) of a house or apartment). In some examples, the image is captured automatically via a wearable carrier device 104 (e.g., smart glasses) worn by a carrier, although any type of carrier device 104 with imaging functionality can be used.

In block 404, the delivery management system 102 may apply the machine learning model 212 to the image received in block 402 to generate a confidence score indicative of whether the environmental features in the received image reflect the delivery address received from the carrier device 104. The machine learning model 212 could have been trained and deployed as explained above with reference to method 300, for example.

While the machine learning model 212 is used in the examples described and illustrated therein, other types of image classification and analysis methods can be used to compare the received image with stored image(s) associated with the same delivery address in order to generate the confidence score in other examples. Additionally, other data (e.g., GPS coordinates of the carrier device 104 upon capture of the image and included in metadata for the image received along with the image by the delivery management system 102) can be compared with corresponding stored data for the delivery address and used to adjust the generated confidence score.

In block 406, the delivery management system 102 may determine whether the confidence score generated in block 404 is above a confidence threshold. The confidence threshold can be static, configurable, and/or dynamic and represents a likelihood that the received image of the delivered package reflects the intended delivery address for the delivered package. If the delivery management system 102 determines that the confidence score is above a confidence threshold, then the “Yes” branch is taken to block 408.

In block 408, the delivery management system 102 may store the image associated with the delivery address in the delivery database 210. Accordingly, the delivery management system 102 can add the received image to a set of images associated with the delivery address in the delivery database 210 to facilitate more images and data (e.g., regarding environmental features) that can be used in future iterations of method 400 for the same delivery address. Subsequent to storing the image, the delivery management system 102 proceeds back to block 402 and receives another image and associated delivery address from the same or another carrier device 104. However, if the delivery management system 102 determines in block 406 that the confidence score generated in block 404 is not above a confidence threshold, then the “No” branch is taken to block 410.

In block 410, the delivery management system 102 may determine whether the confidence score is below a confidence threshold (and/or zero) because insufficient data exists in the delivery database 210 to generate a confidence score. In other words, if nor or too few images associated with the delivery address have been captured, received, and stored previously, then the machine learning model 212 may be unable to effectively generate a confidence score. The amount of data or number of stored images can be configurable in some examples. If the delivery management system 102 determines that sufficient data is stored in the delivery database 210, then the “Yes” branch is taken to block 412.

In block 412, the delivery management system 102 may generate an alert to the carrier device 104 to prompt a user of the carrier device 104 to confirm the delivered package was delivered to the intended delivery address. The alert can be in the form of a push notification, a Short Message Service (SMS) message, or any other type of notification or alert transmitted via the network 110. Since the delivery management system 102 determines that there was sufficient stored data, but the confidence score was below the confidence threshold, then the received image is unlikely to represent the intended delivery address.

In other examples, in place of or in addition to the alert, the delivery management system 102 can generate a message to the recipient device 106 that can include a query regarding any discrepancy in the current image as compared to the stored images. For example, if the delivery management system 102 determines that the front door is a different color, the delivery management system 102 can generate a request to the recipient device 106 to ask whether the front door was recently painted.

In block 414, the delivery management system 102 may receive carrier feedback data from the carrier device 104 in response to the alert generated and sent in block 412. In this example, the carrier feedback data can include a binary indication of whether the user of the carrier device 104 believes that the package was accurately delivered to the appropriate delivery address, although other types of carrier feedback data can also be used in other examples. In some examples, the carrier feedback data is transmitted to the delivery management system 102 via the network 110 (e.g., via a standalone application executing on the carrier device 104 and providing an interface for outputting the alert and receiving the carrier feedback data, and functionality for transmitting the carrier feedback data).

Accordingly, in block 416, the delivery management system 102 may determine whether the carrier feedback data is positive, indicating a belief from the user of the carrier device 104 that the package was delivered to the correct address. If the delivery management system 102 determines that the carrier feedback data is not positive, then the “No” branch is taken back to block 402 and the method 400 is repeated for a different image captured by the carrier device 104 at a different location. In this iteration, the user of the carrier device 104 determined in response to the alert that the package was delivered to the wrong location (e.g., by visually observing a house number that did not match that of the intended delivery address) and re-delivered the package to another location. However, if the delivery management system 102 determines in block 410 that insufficient data is stored in the delivery database 210 and the “No” branch is taken from block 410, or in block 416 that the carrier feedback data is positive and the “Yes” branch is taken from block 416, then the delivery management system 102 proceeds to block 418.

In block 418, the delivery management system 102 may generate a delivery confirmation request to the recipient device 106 via the network 110 and based on retrieved recipient contact data associated with the delivery address and/or the order associated with the delivered package. The delivery management system 102 can obtain the recipient contact data from local storage or a third party (e.g., hosting one of the storage server 108(1)-108(n)), and the recipient contact data can include a unique identifier of an account of a retailer and/or carrier associated with the goods corresponding to the package, an e-mail address, a mobile phone number, or any other type of contact information for the recipient.

In one example, the recipient contact data can include account information for the recipient, and the delivery confirmation request can be a push notification via an application hosted on the recipient device 106 and associated with the account. The delivery confirmation request can include a request to confirm that the package was received, contextual data regarding the delivered package (e.g., the image received in block 402), and/or any other information relating to the package delivery.

In block 420, the delivery management system 102 may receive recipient feedback data from the recipient device in response to the delivery confirmation request. The recipient feedback data also can be binary and indicative of whether the recipient actually received the delivered package (e.g., the package was delivered to the correct address). In other examples, in place of or in addition to the recipient feedback data, the delivery management system 102 can use security camera or other data that is stored by a third party and for which access was previously authorized by the recipient in order to facilitate automated feedback. For example, if the security camera associated with the intended delivery address indicates that a package was delivered at a time that corresponds to the time of the captured image, then the package was likely delivered to the correct address. Other types of data sources and inputs can also be used to facilitate manual and/or automated feedback.

In block 422, the delivery management system 102 may update the machine learning model based on the recipient feedback data. Accordingly, if the recipient feedback data is positive, the delivery management system 102 can store the image associated with the delivery address in the delivery database 210 as described above with reference to block 408 and may continue to train the machine learning model 212 based on the received image such that a subsequent similar image for the same delivery address will result in generation of a higher confidence score in a subsequent iteration of block 404. However, if the recipient feedback data is negative, the delivery management system 102 may not store the image may continue to train the machine learning model 212 based on the received image to confirm the accuracy of the generated confidence score and/or such that a subsequent similar image for the same delivery address will result in generation of a same or lower confidence score in a subsequent iteration of block 404. Subsequent to updating the machine learning model 212, the delivery management system 102 proceeds back to block 402 and receives another image and associated delivery address from the same or another carrier device 104.

One or more of blocks 402-422 can occur in a different order and/or in parallel in other examples. For example, blocks 402-422 can be performed in parallel by the delivery management system 102 for any number of images associated with delivery addresses from any number of carrier devices.

As described and illustrated by way of the examples herein, the delivery management system 102 of this technology advantageously uses image analysis and, optionally, machine learning to determine whether a package was delivered accurately to a correct address based on capture images of delivered packages and stored image of locations corresponding to the intended delivery addresses. This technology generates alerts promptly following receipt and analysis of a captured image and in sufficient time to prompt a carrier to confirm accurate delivery or address an inaccurate delivery by re-delivering a package to a correct address. The delivery management system 102 in some examples of this technology continuously stores additional images and trains a deployed machine learning model 212 based on carrier and recipient feedback data to facilitate improved confidence score accuracy over time and thereby reduce inaccurate deliveries and current associated issues and inefficiencies with last mile delivery services.

### Example Use Case

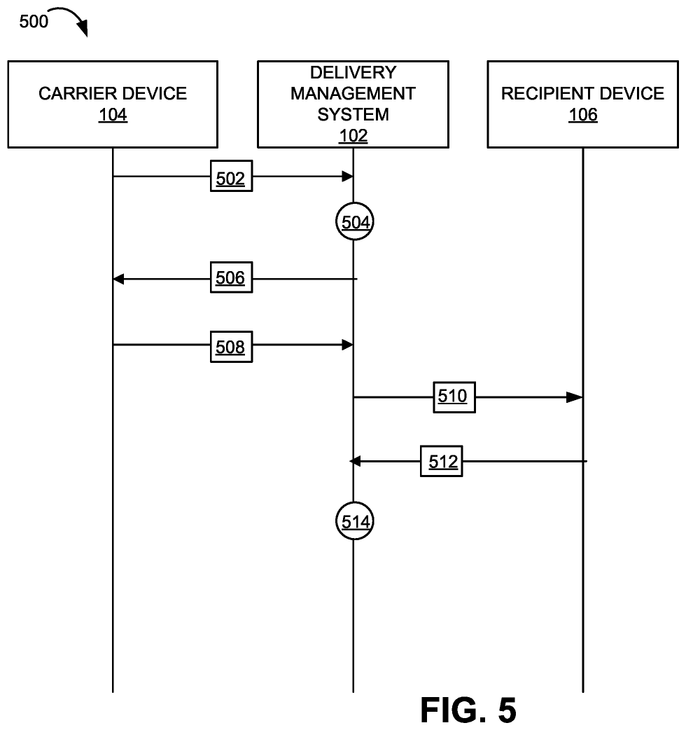

The following example use case describes an example of a typical user flow pattern. This section is intended solely for explanatory purposes and not in limitation. FIG. 5 is a timing diagram of an example method 500 for identifying a potentially-inaccurate package delivery and continuously training the machine learning model 212, in accordance with one or more examples of the disclosed technology. In block 502, a user of the carrier device 104 captures an image of a delivered package and sends the captured image to the delivery management system 102 over the network 110. In this example, the carrier device 104 includes the intended delivery address for the delivered package depicted in the captured and transmitted image, although in other examples the carrier device 104 can send an identifier (e.g., of an associated order or the package itself), which the delivery management system 102 can correlate to retrieve the intended delivery address for the package.

In block 504, the delivery management system 102 applies the machine learning model 212 to the image received by the delivery management system 102 to generate a confidence score indicative of whether environmental features in the image correspond to the intended delivery address. In this particular example, the delivery management system 102 generates a confidence score that is below an established confidence threshold indicating that it is more likely than not that the image represents the intended delivery address, although other thresholds can be used in other examples.

Accordingly, in block 506, the delivery management system 102 generates and sends via network 110 an alert to the carrier device 104 (e.g., via a push notification). The alert indicates that the package may have been delivered to an incorrect address and requests that the user of the carrier device 104 check the location (e.g., the house number) and provide feedback data accordingly.

In block 508, the user of the carrier device 104 returns carrier feedback data in response to the alert. The carrier feedback data in this particular example indicates that the user of the carrier device 104 believes that the package was accurately delivered to the corrected intended delivery address.

In block 510, the delivery management system 102 generates and sends via network 110 a delivery confirmation request to the recipient device 106. The delivery management system 102 can use an identifier for the order or shipment to retrieve contact data (e.g., mobile phone number) stored in a database to send the delivery confirmation request (e.g., via SMS message), although other methods for communicating the delivery confirmation request to the recipient device 106 can also be used in other examples.

In block 512, the user of the recipient device response to the delivery confirmation request by sending recipient feedback data to the delivery management system 102. In this particular example, the recipient feedback data includes a confirmation that the package was in fact correctly delivered to the intended delivery address.

Thus, in block 514, the delivery management system 102 stores the image in the delivery database 210 in a set of images associated with the intended delivery address. Thereby, the machine learning model 212 will consider this additional image in a subsequent iteration for a subsequent package delivered to the delivery address and generate a more accurate confidence score that may exceed the confidence threshold.

In some examples, disclosed systems or methods may involve one or more of the following clauses:

Clause 1: A delivery management system, comprising: one or more processors; and memory in communication with the one or more processors and storing instructions that, when executed by the one or more processors, are configured to cause the delivery management system to: receive a delivery address and an image of a delivered package from a carrier device via a first communication network, wherein the image comprises one or more environmental features associated with a physical location at which the delivered package was delivered; apply a machine learning model to the image to generate a confidence score indicative of whether the environmental features correspond to the delivery address; determine that the confidence score is below a stored confidence threshold; send an alert message to the carrier device via the first network; receive carrier feedback data from the carrier device in response to the alert message; determine that the carrier feedback data is positive; send a delivery confirmation request to a recipient device, via a second communication network and based on obtained recipient contact data associated with the delivery address; receive recipient feedback data in response to the delivery confirmation request; and update the machine learning model based on the recipient feedback data.

Clause 2: The delivery management system of clause 1, wherein the machine learning model is configured to compare the image to a set of one or more images associated with the delivery address and the instructions, when executed by the one or more processors, are further configured to cause the delivery management system to store the image in the set of images associated with the delivery address.

Clause 3: The delivery management system of clause 1, wherein the instructions, when executed by the one or more processors, are further configured to cause the delivery management system to determine that the machine learning model has sufficient data from which to generate the confidence score before generating the alert message.

Clause 4: The delivery management system of clause 1, wherein the environmental features comprise one or more physical attributes of one or more items depicted in the image, wherein the physical attributes comprise a relative location, a color, a size, or graphical indicia encoding data.

Clause 5: The delivery management system of clause 1, wherein the instructions, when executed by the one or more processors, are further configured to cause the delivery management system to: train the machine learning model based on training data comprising a plurality of sets of images, wherein each of the sets of images is associated with one of a plurality of delivery addresses; and deploy the machine learning model when an accuracy threshold is exceeded.

Clause 6: The delivery management system of clause 1, wherein the confidence score is further generated based on delivery context data received from the carrier device and a level of correlation between the image and one or more historical stored images associated with the delivery address, wherein the delivery context data comprises at least a global positioning system (GPS) location.

Clause 7: The delivery management system of clause 1, wherein the instructions, when executed by the one or more processors, are further configured to cause the delivery management system to train the machine learning model further based on one or more images associated with the delivery address and retrieved from a server device via an application programming interface (API).

Clause 8: The delivery management system of claim 1, wherein the instructions, when executed by the one or more processors, are further configured to cause the delivery management system to: identify a change in one of the environmental features from one or more stored historical images associated with the delivery address; and generate the delivery confirmation request to include a request to confirm the change to the one of the environmental features.

Clause 9: A delivery management system, comprising: one or more processors; and memory in communication with the processor and storing instructions that, when executed by the one or more processors, are configured to cause the delivery management system to: receive a delivery address and a first image of a package from a carrier device, wherein the first image comprises a first set of one or more environmental features; apply a machine learning model to the first image to generate a confidence score indicative of a likelihood that the first set of environmental features corresponds to the delivery address; determine that the confidence score is below a confidence threshold value; send an alert to the carrier device; receive carrier feedback data from the carrier device in response to the alert; receive a second image of the package from the carrier device when the carrier feedback data is negative, wherein the second image comprises a second set of one or more environmental features; and repeat at least the application and the determination for the second image.

Clause 10: The delivery management system of clause 9, wherein the machine learning model is configured to compare each of the first image and the second image to a set of one or more images associated with the delivery address and the instructions, when executed by the one or more processors, are further configured to cause the delivery management system to store the second image in the set of images associated with the delivery address.

Clause 11: The delivery management system of clause 9, wherein the instructions, when executed by the one or more processors, are further configured to cause the delivery management system to determine that the machine learning model has sufficient data from which to generate the confidence score before sending the alert.

Clause 12: The delivery management system of clause 9, wherein the environmental features comprise one or more physical attributes of one or more items depicted in the image, wherein the physical attributes comprise a relative location, a color, a size, or graphical indicia encoding data.

Clause 13: The delivery management system of clause 9, wherein the instructions, when executed by the one or more processors, are further configured to cause the delivery management system to train the machine learning model based on training data comprising a plurality of sets of images, wherein each of the sets of images is associated with one of a plurality of delivery addresses.

Clause 14: The delivery management system of clause 9, wherein the confidence score is further generated based on one or more of a global positioning system (GPS) location received from the carrier device or a level of correlation between the image and one or more historical stored images associated with the delivery address.

Clause 15: The delivery management system of clause 9, wherein the instructions, when executed by the one or more processors, are further configured to cause the delivery management system to train the machine learning model based on one or more images associated with the delivery address and retrieved from a third party server.

Clause 16: A delivery management system, comprising: one or more processors; and memory in communication with the one or more processors and storing instructions that, when executed by the one or more processors, are configured to cause the delivery management system to: receive a delivery address and an image of a package from a carrier device via a first network, wherein the image comprises one or more environmental features associated with a location at which the package was delivered; apply a machine learning model to the image to generate a confidence score indicative of whether the environmental features correspond to the delivery address, wherein the machine learning model is configured to compare the image to a set of one or more images associated with the delivery address; determine that the confidence score is above a confidence threshold; and store the image in the set of images associated with the delivery address.

Clause 17: The delivery management system of clause 16, wherein the environmental features comprise one or more physical attributes of one or more items depicted in the image, wherein the physical attributes comprise a relative location, a color, a size, or graphical indicia encoding data.

Clause 18: The delivery management system of clause 16, wherein the instructions, when executed by the one or more processors, are further configured to cause the delivery management system to: train the machine learning model based on training data comprising a plurality of sets of images, wherein each of the sets of images is associated with one of a plurality of delivery addresses; and deploy the machine learning model when an accuracy threshold is exceeded.

Clause 19: The delivery management system of clause 16, wherein the confidence score is further generated based on delivery context data received from the carrier device and a level of correlation between the image and one or more historical stored images associated with the delivery address, wherein the delivery context data comprises at least a global positioning system (GPS) location.

Clause 20: The delivery management system of clause 16, wherein the instructions, when executed by the one or more processors, are further configured to cause the delivery management system to train the machine learning model based on one or more images associated with the delivery address and retrieved from a third party server via an application programming interface (API).

Certain embodiments of the disclosed technology are described above with reference to block and flow diagrams of systems and methods and/or computer program products according to exemplary embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a non-transitory computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A delivery management system, comprising:
one or more processors; and
memory in communication with the one or more processors and storing instructions that, when executed by the one or more processors, are configured to cause the delivery management system to:
receive a delivery address and an image of a delivered package from a carrier device via a first communication network, wherein the image comprises one or more environmental features associated with a physical location at which the delivered package was delivered;
apply a machine learning model to the image to generate a confidence score indicative of whether the environmental features correspond to the delivery address;
determine that the confidence score is below a stored confidence threshold;
send an alert message to the carrier device via the first communication network;
receive carrier feedback data from the carrier device in response to the alert message;
determine that the carrier feedback data is positive;
send a delivery confirmation request to a recipient device, via a second communication network and based on obtained recipient contact data associated with the delivery address;
receive recipient feedback data in response to the delivery confirmation request; and
update the machine learning model based on the recipient feedback data.

2. The delivery management system of claim 1, wherein the machine learning model is configured to compare the image to a set of one or more images associated with the delivery address and the instructions, when executed by the one or more processors, are further configured to cause the delivery management system to store the image in the set of images associated with the delivery address.

3. The delivery management system of claim 1, wherein the instructions, when executed by the one or more processors, are further configured to cause the delivery management system to determine that the machine learning model has sufficient data from which to generate the confidence score before generating the alert message.

4. The delivery management system of claim 1, wherein the environmental features comprise one or more physical attributes of one or more items depicted in the image, wherein the physical attributes comprise a relative location, a color, a size, or graphical indicia encoding data.

5. The delivery management system of claim 1, wherein the instructions, when executed by the one or more processors, are further configured to cause the delivery management system to:
train the machine learning model based on training data comprising a plurality of sets of images, wherein each of the sets of images is associated with one of a plurality of delivery addresses; and
deploy the machine learning model when an accuracy threshold is exceeded.

6. The delivery management system of claim 1, wherein the confidence score is further generated based on delivery context data received from the carrier device and a level of correlation between the image and one or more historical stored images associated with the delivery address, wherein the delivery context data comprises at least a global positioning system (GPS) location.

7. The delivery management system of claim 1, wherein the instructions, when executed by the one or more processors, are further configured to cause the delivery management system to train the machine learning model further based on one or more images associated with the delivery address and retrieved from a server device via an application programming interface (API).

8. The delivery management system of claim 1, wherein the instructions, when executed by the one or more processors, are further configured to cause the delivery management system to:
identify a change in one of the environmental features from one or more stored historical images associated with the delivery address; and
generate the delivery confirmation request to include a request to confirm the change to the one of the environmental features.

9. A delivery management system, comprising:
one or more processors; and
memory in communication with the one or more processors and storing instructions that, when executed by the one or more processors, are configured to cause the delivery management system to:
receive a delivery address and a first image of a package from a carrier device, wherein the first image comprises a first set of one or more environmental features;
apply a machine learning model to the first image to generate a confidence score indicative of a likelihood that the first set of environmental features corresponds to the delivery address;
determine that the confidence score is below a confidence threshold value;
send an alert to the carrier device;
receive carrier feedback data from the carrier device in response to the alert;
receive a second image of the package from the carrier device when the carrier feedback data is negative, wherein the second image comprises a second set of one or more environmental features; and
repeat at least the application and the determination for the second image.

10. The delivery management system of claim 9, wherein the machine learning model is configured to compare each of the first image and the second image to a set of one or more images associated with the delivery address and the instructions, when executed by the one or more processors, are further configured to cause the delivery management system to store the second image in the set of images associated with the delivery address.

11. The delivery management system of claim 9, wherein the instructions, when executed by the one or more processors, are further configured to cause the delivery management system to determine that the machine learning model has sufficient data from which to generate the confidence score before sending the alert.

12. The delivery management system of claim 9, wherein the environmental features comprise one or more physical attributes of one or more items depicted in the first image, wherein the physical attributes comprise a relative location, a color, a size, or graphical indicia encoding data.

13. The delivery management system of claim 9, wherein the instructions, when executed by the one or more processors, are further configured to cause the delivery management system to train the machine learning model based on training data comprising a plurality of sets of images, wherein each of the sets of images is associated with one of a plurality of delivery addresses.

14. The delivery management system of claim 9, wherein the confidence score is further generated based on one or more of a global positioning system (GPS) location received from the carrier device or a level of correlation between the first image and one or more historical stored images associated with the delivery address.

15. The delivery management system of claim 9, wherein the instructions, when executed by the one or more processors, are further configured to cause the delivery management system to train the machine learning model based on one or more images associated with the delivery address and retrieved from a third party server.

16. A delivery management system, comprising:
one or more processors; and
memory in communication with the one or more processors and storing instructions that, when executed by the one or more processors, are configured to cause the delivery management system to:
receive a delivery address and an image of a package from a carrier device via a first network, wherein the image comprises one or more environmental features associated with a location at which the package was delivered;
apply a machine learning model to the image to generate a confidence score indicative of whether the environmental features correspond to the delivery address, wherein the machine learning model is configured to compare the image to a set of one or more images associated with the delivery address;
determine that the confidence score is above a confidence threshold; and
store the image in the set of images associated with the delivery address.

17. The delivery management system of claim 16, wherein the environmental features comprise one or more physical attributes of one or more items depicted in the image, wherein the physical attributes comprise a relative location, a color, a size, or graphical indicia encoding data.

18. The delivery management system of claim 16, wherein the instructions, when executed by the one or more processors, are further configured to cause the delivery management system to:
train the machine learning model based on training data comprising a plurality of sets of images, wherein each of the sets of images is associated with one of a plurality of delivery addresses; and
deploy the machine learning model when an accuracy threshold is exceeded.

19. The delivery management system of claim 16, wherein the confidence score is further generated based on delivery context data received from the carrier device and a level of correlation between the image and one or more historical stored images associated with the delivery address, wherein the delivery context data comprises at least a global positioning system (GPS) location.

20. The delivery management system of claim 16, wherein the instructions, when executed by the one or more processors, are further configured to cause the delivery management system to train the machine learning model based on one or more images associated with the delivery address and retrieved from a third party server via an application programming interface (API).
